(19) United States
(12) Patent Application Publication
(10) Pub. No.: US 2006/0246889 A1
(43) Pub. Date: Nov. 2, 2006

(54) Wireless Data Device Performance Monitor

(76) Inventors: Peter K. Buchhop, Cary, IL (US); Anne B. Fyk, Highland Park, IL (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 10/908,201

(22) Filed: May 2, 2005

(51) Int. Cl. H04Q 7/20

(52) U.S. Cl. 455/425; 455/423

(57) ABSTRACT

A wireless monitoring module monitors a performance of a wireless data device. The module, which is executed by the wireless data device, sends an application request at predetermined time intervals. The module receives a response from the request. If the response is successful, there is either no error, or an application problem, depending on the content of the response. If the response is an error, the module determines whether the error is due to a network problem or a wireless gateway problem.

### FIELD OF THE INVENTION

One embodiment of the present invention is directed to wireless data devices. More particularly, one embodiment of the present invention is directed to a performance monitor for wireless data devices.

### BACKGROUND INFORMATION

Wireless data devices, such as the BlackBerry handheld device from RIM Corporation, have proliferated in recent years. The popularity of these devices is based on their ability to receive e-mail and other data remotely so that the user can always be “in touch” with the office and can access remote applications.

Many of these devices have a “push” architecture that eliminates the hassles of the traditional “pull” devices, in which the user must periodically connect to an e-mail server to check for new messages, or click on an embedded Web link to receive data. In contrast, with a push device, e-mail messages and other data such as documents are automatically routed to the handheld device, without the active participation of the user.

In order for a wireless data device to properly receive e-mails or access remote applications, data communications must go through multiple layers or “tiers”, such as a tier that includes a carrier network and a network operation center for the wireless data device, a wireless gateway tier, and an application tier. However, if there is a malfunction in any one of these tiers, the wireless data device function will not be successful.

Current tools are available to monitor applications and other functionality that may be accessed from wireless data devices. For example, the Mercury SiteScope from Mercury Interactive Corporation is an agentless monitoring solution designed to ensure the availability and performance of distributed IT infrastructures—e.g., servers, operating systems, network devices, network services, applications, and application components. However, SiteScope only measures the functionality at the application tier. Therefore, if a wireless data device cannot access an application, but the problem is at a tier other than the application tier, a monitoring tool such as SiteScope will be unable to determine the source of the problem or errors.

Based on the foregoing, there is a need for a system and method for monitoring wireless data devices to determine the source of errors among the multiple tiers between the wireless data devices and the applications.

### SUMMARY OF THE INVENTION

One embodiment of the present invention is a wireless monitoring module for monitoring a performance of a wireless data device. The module, which is executed by the wireless data device, sends an application request at predetermined time intervals. The module receives a response from the request. If the response is successful, there is either no error, or an application problem, depending on the content of the response. If the response is an error, the module determines whether the error is due to a network problem or a wireless gateway problem.

### BRIEF DESCRIPTION OF THE DRAWINGS

FIG. 1 is a block diagram of the functional elements of a system for monitoring the performance of the wireless data device in accordance with one embodiment of the present invention.

FIG. 2 is a flow diagram of the functionality performed by a wireless monitoring module and the system to monitor and pinpoint the source of errors between the wireless data device and an application in accordance with one embodiment of the present invention.

### DETAILED DESCRIPTION

One embodiment of the present invention is a wireless data device performance monitor that monitors and pinpoints the source of errors between the wireless data device and an application. As a result, all tiers of the wireless data device system can be monitored

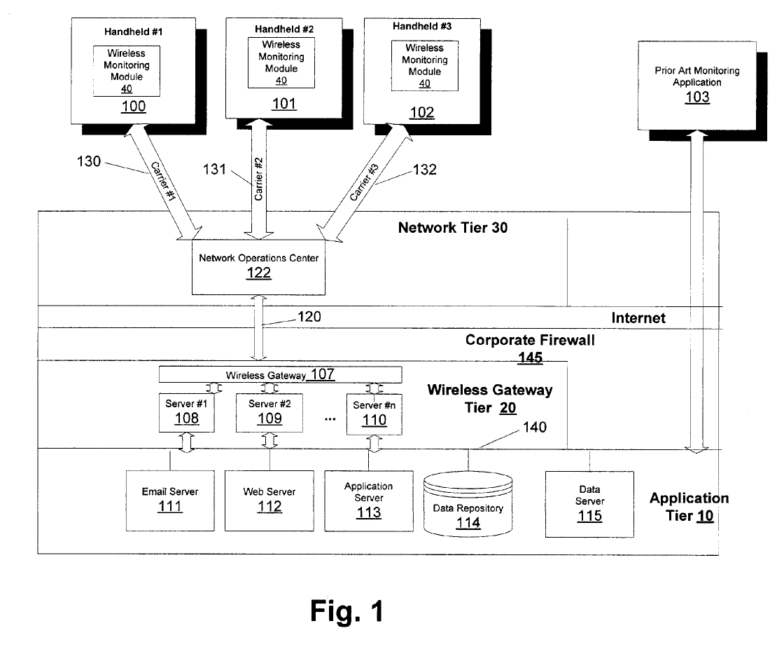

FIG. 1 is a block diagram of the functional elements of a system 50 for monitoring the performance of the wireless data device in accordance with one embodiment of the present invention. The functional elements shown in FIG. 1 can be implemented with any combination of hardware or software, including software executed by multiple computer systems or servers.

System 50 includes a wireless gateway 107 that includes one or more wireless gateway servers 108-110 that take electronic information and make it compatible for transmission across a wireless network by encoding it in transmission protocols applicable to the wireless network. Wireless gateway 107 communicates this electronic data to a network operations center 122 across a communication network 120. Network operations center 122 monitors and manages various computer systems which interface to a carrier's wireless network 130-132. The wirelessly transmitted electronic information is received and displayed by wireless data devices 100-102. In one embodiment, wireless data devices 100-102 are BlackBerry handheld devices from RIM Corporation, and wireless gateway servers 108-110 are BlackBerry Enterprise Servers executing Mobile Data Service. However, other types of wireless data devices and gateway servers can be used in different embodiments of the present invention.

System 50 further includes a Web server 112 that in one embodiment includes multiple Web servers and one or more load balance servers. Web server 112 receives and interprets electronic messages encoded in various internet-compatible protocols, such as HyperText Transfer Protocol (“HTTP”) or File Transfer Protocol (“FTP”). Web server 112 may be an internal corporate intranet server, or any external internet server coupled to the Internet.

An application server 113 includes one or more application programs running on one or more application servers in a clustered environment. Application server 113 contains business rules and program logic, responds to user requests and processes and formats data in a manner consistent with wireless data devices 100-102.

In one embodiment, the number of wireless data devices 100-102 in communication with wireless gateway 107 can number in the thousands, and each are provisioned on a particular wireless gateway server from the set of multiple wireless gateway servers 108-110. In one embodiment, each of wireless data devices 100-102 include a storage/repository for storage of data and a processor for executing software instructions.

A data repository 114 provides long-term data storage for system 50. The storage may take the form of relational or hierarchical databases, sequential flat file storage, or any other method that allows data to be stored and retrieved.

A data server 115 allows system 50 to interface with one or more independent external data sources, such as 3rd party financial or market data systems, news services, or any other source of electronic data that may be transformed and represented in a wireless markup language format or other format for pushing and displaying on wireless data devices 100-102. In one embodiment, the electronic data is formatted in accordance with the “Push Access Protocol” of the “Wireless Application Protocol”.

System 50 further includes an electronic mail (“e-mail”) server 111 for handling e-mail. E-mail server 111 in one embodiment is an “Outlook” server that provides e-mail services using a Microsoft Corp. Outlook e-mail application program. However, e-mail server 111 may be any known e-mail server.

E-mail server 111, Web server 112, application server 113, data repository 114 and data server 115 in one embodiment are coupled to each other via a communication network 140 and form the application tier 10 of system 50. Wireless gateway 107 (including wireless gateway servers 108-110) form the wireless gateway tier 20 of system 50 and is coupled to application tier 10. In a corporate or large entity environment, wireless gateway tier 20 and application tier 10 are typically configured behind a corporate firewall 145.

Wireless gateway 107 communicates with network operations center 122 through communication link 120 across the Internet. Network operations center 122 is typically owned and operated by the provider of wireless data devices 100-102 (e.g., Blackberry). Network operations center 122 communicates to wireless data devices 100-102 via wireless carriers 130-132. Wireless carriers 130-132 are the wireless providers through which the user of each wireless data device 100-102 subscribes to. For example, carrier 130 may be Verizon Wireless and carrier 131 may be Cingular Wireless. Network operations center 122 and wireless carriers 130-132 form network tier 30.

A prior art monitoring application 103, such as SiteScope, goes through firewall 145 to application tier 10, and therefore only monitors application tier 10, as shown in FIG. 1. In contrast, one embodiment of the present invention is a software wireless monitoring module 40 that is executed by wireless data devices 100-102 and that goes through network tier 30. Therefore, for example, if there is a failure with a Cingular or Verizon tower or network, that information can be captured by monitoring module 40. In addition, in one embodiment of the present invention, once network tier 30 is cleared of any failure, monitoring module 40 goes through the Internet and corporate firewall 145 to wireless gateway tier 20 and then it hits application tier 10. If a user of wireless data device 100, for example, attempts to access a Web site on Web server 112 through a browser, the browser must go through network tier 30, wireless gateway tier 20 and application tier 10 to successfully access the web site. All of these tiers are monitored by an embodiment of the present invention.

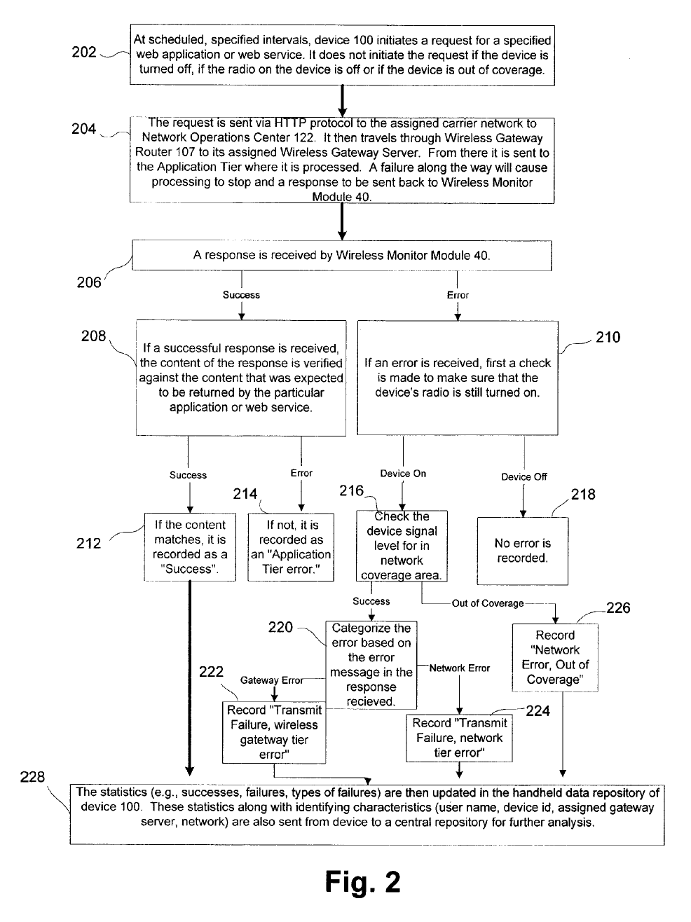

FIG. 2 is a flow diagram of the functionality performed by wireless monitoring module 40 and system 50 to monitor and pinpoint the source of errors between wireless data device 100 and an application, such as a Web site, that the wireless data device 100 is attempting to access in accordance to one embodiment of the present invention. In one embodiment, the functionality is implemented by software stored in memory and executed by a processor. In other embodiments, the functionality can be performed by hardware, or any combination of hardware and software.

202: At scheduled predetermined time intervals, wireless monitoring module 40 initiates a request for a specified Web application or Web service from Web server 112. It does not initiate the request if wireless data device 100 that executes the wireless monitoring module is turned off or if the radio on the wireless data device is off. In other embodiments, wireless monitoring module 40 accesses another application in application tier 10, such as an application from application server 113.

In one embodiment, wireless monitoring module 40 at 202 requests a Web page that is stored on Web server 112 and is specifically designed for use with wireless monitoring module 40. Therefore, the content of the correct response or Web page received by wireless monitoring module 40 is known in advance of the request.

204: The request is sent via HTTP protocol to the assigned carrier network (e.g., carrier 130) and then to network operations center 122. The request then travels through wireless gateway router 107 to its assigned wireless gateway server out of wireless gateway servers 108-110. From there it is sent to Web server 112 in application tier 10. A failure along the way will cause processing to stop and a response to be sent back to wireless monitor module 40.

206: A response is received by wireless monitor module 40.

208: If a successful response is received at 206, the content of the response is verified against the content that was expected to be returned by the particular application or Web service. In one embodiment, a response is “successful” when a successful response code is returned from the application programming interface (“API”) and no low level software exceptions are detected.

210: If an error is received at 206, a check is made to make sure that the wireless radio on the wireless data device 100 continues to be turned on

212: If the content of the response matches the expected content at 208, the request is characterized/recorded as a “success”. For example, the request may have been a Web page, so the response should be a Web page that matches the expected Web page.

214: If the content does not match at 208, the request is characterized as an “application tier error” or application problem.

216: If wireless data device 100 is on at 210, the signal level for the network coverage area for wireless data device 100 is checked.

218: If wireless data device 100 is off at 210, no error is recorded.

220: If wireless data device 100 is within an adequate signal level at 216 for network coverage, the error is categorized based on the error message in the received response at 206, which indicates a wireless gateway tier 20 error or a network tier 30 error. In the embodiment in which wireless data device 100 is a BlackBerry device from RIM, a programmatic check is performed via the RIM API to determine whether the device is in or out of coverage using the following code: RadioInfo.getSignalLevel( )==RadioInfo.LEVEL_NO_COVERAGE).

222: If a wireless gateway tier 20 error at 220, the error is categorized as a “transmit failure, wireless gateway tier error” or wireless gateway tier problem.

224: If a network tier 30 error at 220, the error is categorized as a “transmit failure, network tier error” or network tier problem.

226: If wireless data device 100 is within an adequate signal level at 216 for network coverage at 226, the error is categorized as a “network error-out of coverage”.

228: The statistics (i.e., successes, failures, types of failures) are then updated in the handheld repository of wireless data device 100. These statistics, along with identifying characteristics (e.g., user name, device ID, assigned gateway server, network, etc.) are also sent from wireless data device 100 to data repository 114 for further analysis by operators at application tier 10.

As disclosed, an embodiment of the present invention periodically requests an application from the wireless data device. The request passes through the network tier, including the carrier network and network operation center, and then goes through the firewall to the wireless gateway tier before hitting the application tier. Based on the response received from the request, any error can be pinpointed to one of the three.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of monitoring a performance of a wireless data device, comprising:
sending an application request at predetermined time intervals from the wireless data device;
receiving a response to the request; and
based on the response, determining if an error is based on a network problem, a wireless gateway problem, or an application problem.

2. The method of claim 1, wherein the error is determined to be an application problem if the response is successful, and the expected content of the response is not received.

3. The method of claim 1, wherein the error is determined to be an wireless gateway problem or a network problem if the response is an error message.

4. The method of claim 4, wherein the error is determined to be the wireless gateway problem based on the error message.

5. The method of claim 1, further comprising:
generating a statistic in connection with the error; and
storing the statistic in a first storage that is local to the wireless data device.

6. The method of claim 5, further comprising:
storing the statistic in a second storage that is positioned in an application tier of the system.

7. The method of claim 1, wherein the application request is a request for a Web page.

8. The method of claim 1, wherein the network problem comprises a problem with a carrier network or a network operations center.

9. A computer readable medium having instructions stored thereon that, when executed by a processor in a wireless data device, cause the processor to:
send a request for an application;
receive a response to the request; and
based on the response, determine if an error is based on a network failure, a wireless gateway failure, or a failure of the application.

10. The computer readable medium of claim 9, wherein the request is a Web page request.

11. The computer readable medium of claim 9, wherein the error is determined to be an application failure if the response is successful, and the expected content of the response is not received.

12. The computer readable medium of claim 9, wherein the error is determined to be an wireless gateway failure or a network failure if the response is an error message.

13. The computer readable medium of claim 12, wherein the error is determined to be the wireless gateway problem based on the error message.

14. The computer readable medium of claim 9, further comprising:
generating a statistic in connection with the error; and
storing the statistic in a first storage that is local to the wireless data device.

15. The computer readable medium of claim 14, further comprising:
storing the statistic in a second storage that is positioned local to the application.

16. A wireless data device performance monitoring module comprising:
means for sending a request for an application;
means for receiving a response to the request; and
based on the response, means for determining if an error is based on a network failure, a wireless gateway failure, or a failure of the application.

17. The wireless data device performance monitoring module of claim 16, wherein the application is a Web page.

18. The wireless data device performance monitoring module of claim 16, wherein the error is determined to be an application failure if the response is successful, and the expected content of the response is not received.

19. The wireless data device performance monitoring module of claim 16, wherein the error is determined to be an wireless gateway failure or a network failure if the response is an error message.

20. The wireless data device performance monitoring module of claim 16, wherein the error is determined to be the wireless gateway problem based on the error message.

21. The wireless data device performance monitoring module of claim 16, further comprising:
means for generating a statistic in connection with the error; and
means for storing the statistic in a first storage that is local to the wireless data device.

22. The wireless data device performance monitoring module of claim 21, further comprising:
means for storing the statistic in a second storage that is positioned local to the application.
